(19) United States
(12) Patent Application Publication
(10) Pub. No.: US 2007/0001680 A1
(43) Pub. Date: Jan. 4, 2007

(54) Condition detection and indicating means for a storage battery

(76) Inventor: Teng Cheok Khoo, BAYAN LEPAS (MY)

Correspondence Address: TAYLOR RUSSELL & RUSSELL, P.C., 4807 SPICEWOOD SPRINGS ROAD, BUILDING TWO SUITE 250, AUSTIN, TX, 78759, US

(21) Appl. No.: 10/543,116

(22) PCT Filed: Jan. 21, 2004
(86) PCT No.: PCT/GB04/00194

§ 371 Date: May 15, 2006

(30) Foreign Application Priority Data
Jan. 21, 2003 (GB) 0301342.2

(51) Int. Cl. G01N 27/416

(52) U.S. Cl. 324/430

(57) ABSTRACT

There is disclosed a storage battery which is capable of self-monitoring by detecting and indicating the actual capacity and the expected remaining life-span of the battery, the condition of its charging system and the discharge level. The battery is provided with an integrally assembled detection and indicating means which measure the actual potential across its terminal (indicative of the state of charge of the battery) and the internal resistance of the battery (indicative of its health). The expected remaining life-span of the battery is derived from the calculation of current from these measurements. The battery is assembled to include a casing (2), a cover (3) and a capacity detection and indicating means. The detection and indicating means consist of an electronic circuit that measures the electromotive force and the internal resistance of the battery and indicate the same on a display means (9). The display means is adapted to exhibit whether the battery is in good working condition or otherwise during engine off or whether the charging system of the vehicle is in good working condition during engine in operation. Further, it could also monitor potential leakage presence in its electrical system.

### BACKGROUND TO THE INVENTION

1. Field of the Invention

This invention relates generally to condition detection and indicating means for an electrical storage battery. Particular embodiments of this invention also provide a storage battery having condition detection and indicating means integrally assembled thereto.

Electrical storage batteries are in widespread use. Such batteries are used in a wide range of applications including but not limited to automotive, powerboat, lighting, uninterruptible power supply (UPS) devices, and so forth. In these applications, the battery is typically charged from a source of mains power or from an engine-driven generator. Of late, batteries are being used in autonomous equipment such as display signs and communication base stations that do not have a connection to mains electricity. In such cases, the battery may be charged from a renewable energy source such as an array of photovoltaic cells or a wind turbine. Reliable operation of such apparatus is dependent upon the battery being in good condition.

It is of prime importance to appreciate the distinction between the condition of a battery and the state of charge of a battery. A battery can be in excellent condition and fully discharged. Likewise, a battery in poor condition can be fully charged. The definition of the condition of a battery is dependent upon its application. For example, the condition of a battery used to start an internal combustion engine might be defined as the ability of the battery to supply a large current to the starter motor. Transiently, such a load may be an almost short-circuit on the battery. (This current is conventionally designated CCA, standing for cold-cranking amperage.) As applied to a UPS or autonomous device, the condition may be defined as the total energy that can be provided by the battery when fully charged. In both of these cases, the condition of the battery will inevitably deteriorate as the battery ages. Such deterioration can be arise from various causes. One prime cause is loss of conductive area in the battery plates. In many cases loss of condition will not be reflected in the output of a conventional voltmeter placed across the battery. A voltmeter records only the open-circuit voltage of the battery: a property that can remain substantially unchanged until the battery is close to total failure. Likewise, monitoring the density (specific gravity) of the electrolyte in a lead-acid battery can yield only limited information, and in many cases, ongoing deterioration of the condition of the battery will not cause the specific gravity of the electrolyte to change.

2. Summary of the Prior Art

Conventionally, the energy-storage capacity of a battery has been measured by charging the battery fully and then discharging it through a resistive load. This is a procedure that is time-consuming, that is potentially harmful to the battery, and that requires the battery to be taken out of service. This latter point ensures that such testing is rarely performed on a battery that is in use, for example, in a vehicle.

An integrally assembled monitoring device to measure the operating condition of a storage battery has also been proposed before. For example, U.S. Pat. No. 5,841,357 describes a battery electrolyte monitor that includes a one-piece monitor having a probe housing with its associated circuitry and connecting leads. The connecting leads may be permanently or temporarily attached to the battery electrical output. After removing the battery filler cap, the probe is inserted into the filler cap opening on the battery. The monitor's electrolyte level indicator provides an indication of the electrolyte level. If the indicator does not illuminate, electrolyte must be added to the battery. In another example, U.S. Pat. No. 4,913,987 describes a replacement for a conventional battery filler cap with a cap and a single wire and a sensor probe. Externally mounted circuitry monitors the voltage of the probe when it is immersed in the electrolyte. If the probe voltage drops below a predetermined value, the externally mounted monitor flashes an LED.

GB-A-2 328 288 discloses a method and apparatus for testing a battery in which a transient microcharge or microload is applied to a battery and the resultant voltage profile is analysed. The microload or microcharge, as the case may be, comprises 2 to 100 or more pulses each of 1 to 1000 ms. Such a load profile would not be suitable for measuring short-circuit load of a battery capable of delivering a high current, such as a lead-acid battery, because this would result in excessive energy dissipation.

Limitations on the applicability, accuracy and convenience of such known methods are apparent. None satisfactorily measures the CCA or the energy storage capacity of the battery. This is especially true of existing devices that monitor only some of the cells of a battery. There may be instances where most of the battery cells are in good working condition and only one or two are not. If it happens that such a measurement and monitoring device operates on a good cell, then the actual working capacity of the battery may be misinterpreted.

### SUMMARY OF THE INVENTION

Given the limitations of known devices, there is a demand for a detecting and monitoring device for use with or within a storage battery to assist a user in determining the condition of the battery in an easy and most efficient manner. There is also a demand for a detecting and monitoring device that is capable of monitoring the condition of the charging system to which a battery is connected.

It is proposed that apparatus is provided for connection to a storage battery, or provided integrally with the battery, that measures and indicates the internal impedance of the battery. It is the internal impedance that is predominantly determinative of the CCA. The apparatus preferably also measures and indicates the potential across its terminals in a manner that appears continuous to a user.

From a first aspect, this invention provides apparatus for monitoring the condition of a storage battery comprising first and second connection conductors each for connection to a respective output terminal of the battery, switching means connected in series with a resistance between the connection conductors and voltage measurement means connected in parallel with the resistance, in which the switching means operates to complete the circuit to allow current to flow between the battery terminals, and voltage measurement means being operative to measure the potential across the resistance during such current flow, the period during which the switching means is closed and the frequency of such closures being such that the power dissipated by the apparatus averaged over several closures being substantially less than the instantaneous power delivered by the battery and in which the current drawn during each closure is of the same order as the short-circuit current of the battery.

For example, the duration of the closure may be of order 10⁻⁵ s or less. For example, they may be several tens of μs, for example, 20 μs. Because deterioration of a storage battery occurs over a period of months or years, the test need not be repeated rapidly. This fact can be used to ensure that the testing does not cause a significant drain on the charge of the battery. The period of repetition at which such closures is repeated may be in the order of milliseconds, seconds, minutes, or longer—for example, approximately 10 s. In order to reduce further the power consumption of the apparatus, it may be programmed to go into a sleep mode if the battery EMF remains constant for more than a predetermined period of time. In sleep mode, the periodic testing cycles are suspended, so reducing the drain on the battery to a minimum.

From the voltage measurements, the current can be determined using Ohm's law (current=voltage/resistance). By ensuring the period of current flow is suitably small and their frequency is suitably low, the apparatus need not be constructed to dissipate high power, nor will the battery be noticeably discharged by the action of the apparatus.

It will be noted that the connection to the output terminals of the battery can be made externally of the battery or within the battery. The latter case is particularly appropriate for embodiments that are provided integrally with a battery.

Advantageously, the resistance of the apparatus while the switching means is closed is of the same order (and preferably almost equal to) the load of minimum resistance that the battery is intended to power. For example, where the battery is a starter battery, the resistance of the apparatus may be similar to the resistance of a motor when the motor is in a stalled or full-load condition. In such a condition, the instantaneous current through the apparatus will be approximately the actual CCA of the battery.

In a typical lead acid battery, there is at least a pair of positive and negative internal plates made of lead or an alloy of lead or other metals, the plates within each pair being separated by plate separator. These plates have their own internal resistance associated with it and a good battery will have a substantially low resistance whereas a bad battery will have a high resistance (commonly referred to in the field as an “abnormal internal resistance” or “AIR”). A low resistance implies a high cranking power of the battery and a high resistance implies low cranking power. Therefore, the remaining expected lifespan of the battery may be determined by calculating the discharge current and therefore the internal resistance. The calculated discharge current may then compared to preset value to determine its condition to be displayed on the display means. The preset values may be programmed or loaded into the related component in the detection and indicating means of the battery in accordance to a normal values associated with a good battery of the similar type.

In typical embodiments, the switching means incorporates a semiconductor switching device, such as a MOSFET or a bipolar transistor. While it may at first sight appear to be at best foolhardy to short-circuit a lead-acid battery through a transistor, provided that the current pulses are sufficiently short, insufficient energy will be dissipated within the device to cause it harm. The inventor has found that this allows a device of very surprisingly small size to be used given the instantaneous magnitude of the current. The switching device may be controlled by an output from a microcontroller.

The resistance of a storage battery in good condition is often very low. For example, in the case of a typical car battery, the resistance may be as low as 0.002Ω to 0.005Ω per cell, giving a total of approximately 0.01Ω to 0.03Ω. Therefore, care must be taken to ensure that the resistance of apparatus embodying the invention is sufficiently low that its resistance does not significantly reduce the current flowing from the battery. In particular, conductors that connect the apparatus to the battery must be of sufficiently low resistance so a not to dominate the resistance of the battery. In this regard, embodiments of the invention may conveniently be incorporated within the case of the battery itself. In such embodiments, the apparatus can be calibrated for use with the particular battery during manufacture. Alternatively, the apparatus may be configured to be suitable for external connection to an existing battery. Moreover, the resistance across which the voltage measurement is taken may be the internal resistance of the switching device itself.

The indicating means is preferably of a type that is convenient to refer to, i.e. capable of indicating whether the battery is in good working condition or not while the engine is not running, and whether or not the charging system of the vehicle is in good working condition while the engine is in operation. Use of LEDs is preferred for the indicating means along with other suitable indicators known in the art. Convenience in usage, accuracy in assessing the actual capacity of the storage battery and the ability to assess the condition of its charging system along with other benefits are some of advantageous that could be acquired through the present invention. Embodiments of the invention may alternatively or additionally be configured to provide a display of battery condition within the cabin of a vehicle to which a battery is fitted. Such embodiments may provide display hardware, for example, including several status LEDs. Alternatively, it may interface with a control and instrumentation system of the vehicle to provide a display integrated within the vehicle's instrumentation system. Such latter embodiments may interface with the vehicle's electronics through an industry standard interface.

The appparatus may be further provided with audible warning means operative to issue an audible warning signal when the battery or charging system is in an abnormal condition.

Further embodiments of the invention (particularly, but not exclusively applicable for use in autonomous equipment) may include communications means for conveying the state of a battery to a remote location. For example, the communication means might typically use wireless telecommunication, either as a radio link or cellular telephony.

In order that failure of charging circuitry can be detected and even predicted, embodiments of the invention may include means for monitoring a voltage waveform of the output of the charging circuitry. In many cases, the source of power for charging the battery is an alternating current source. The power source may be an alternator (which generates a three-phase or polyphase AC output) or mains, which may be single-phase, three-phase or polyphase AC. In such cases, a rectifier circuit is used to convert the AC to DC with which to charge the battery. Embodiments of the invention may include means for monitoring the output of the rectifier, with the object of detecting a change in the shape of the output waveform that might indicate failure or imminent failure of the rectifier.

From another aspect, the invention provides a storage battery (for example, a lead-acid storage battery) comprising apparatus according to the first aspect of the invention. In such embodiments, the apparatus may be incorporated into the battery during manufacture.

Embodiments of this aspect may provide a display integral with the battery to indicate its condition. Alternatively or additionally, the battery may include an interface to the apparatus whereby the condition of the battery can be communicated to external apparatus such as a data bus or to communication apparatus.

Accordingly, it is another aim of the invention to provide a storage battery that is provided with an integrated detection and indication means to continuously monitor the actual capacity and the expected remaining lifespan of the battery.

From another aspect, the invention provides a storage battery having detection and indicating means integrally assembled on it, comprising;

a casing having an upper portion and a lower portion, at least a cell defined within the casing;

a cover enclosing the upper portion of the casing;

a pair of terminals mounted on the cover, each terminal is electrically connected to the corresponding anode and cathode of the cell;

characterised in that,

the detection and indicating means includes an electronic circuit, the electronic circuit being adapted to measure the internal resistance of the storage battery and the electromotive force between the pair of terminals, and from the measurements, compare the measured electromotive force with a pre-determined value set in the electronic circuit and calculate the current, whereby the calculated current correspondingly indicates the expected remaining life-span of the storage battery and the measured electromotive force indicates the condition of the storage battery based on the preset value on a display means.

Preferably, the detection and indicating means is configured as an electronic circuit.

Preferably, the electronic circuit is to be assembled and embedded within the cover of the storage battery.

Also preferably, an optional communication means is provided to transmit logical signals generated by the electronic circuit to a remote display means. The generated signals may also be used as source for further processing by the engine management system of the vehicle.

It is also preferable that the battery is also provided with a collapsible carrying handle.

Yet, it is also preferable that the display means include use of a light emitting diode, a bar display device or a segmented display device, which can optionally display icons to indicate the status of the battery.

In preferred embodiments, the detection and indicating means also measures the total potential across all cells of the battery. As is well known, this measurement can be used to give an indication of the state of charge of the battery. While this does not, as has been discussed, provide an indication of the condition of the battery, it does, nevertheless, a provide useful information about the battery.

### BRIEF DESCRIPTION OF THE DRAWINGS

In the drawings:

FIG. 1 is perspective view of a storage battery embodying the invention;

FIG. 2 is a perspective view of another storage battery embodying the invention;

FIG. 3 is a diagrammatic representation of a storage battery having an integrally assembled capacity detection and indicating means embodying the invention;

FIG. 4 shows the characteristic of electromotive force waveform in a vehicle battery during different vehicle engine conditions;

FIG. 5 is another diagrammatic representation of the battery embodying the invention together with its charging system;

FIG. 6 is a diagram of showing the functional layout of the measuring circuit within the embodiment of FIG. 1; and

FIG. 7 shows a graphical display being a component of some embodiments of the invention.

### DETAILED DESCRIPTION OF THE PREFERRED EMBODIMENTS

Embodiments of the invention will now be described in detail, by way of example, and with reference to the accompanying drawings.

FIG. 1 shows a perspective view of a storage battery being an embodiment of the present invention having integral apparatus for monitoring its condition. Embodiments of batteries such as this can be can be classified into two broad subclasses. A first embodiment has a display that is integral with the battery. This display must be viewed directly, so may require a user to open the engine compartment of a vehicle to examine it (although an audible warning device may be provided that can be heard without doing this). The advantage of embodiments such as this is that it can be provided in a replacement battery for an existing vehicle without any installation other than replacement of the battery. An alternative class of embodiments provides a signal that conveys a signal representative of the condition of the battery to apparatus external of the battery such as a control bus of the vehicle. Such embodiments are more convenient, but are generally suitable only for installation to a suitably-equipped vehicle, and are therefore most typically OEM products.

The battery of this embodiment is a six-cell, 12V lead-acid battery for a motor vehicle, specifically, in accordance with the DIN66 standard. Such a battery in good condition has an internal resistance of 0.005Ω per cell, giving a total internal resistance of 0.03Ω. By simple application of Ohmn's law, it will be seen that the battery can potentially deliver a maximum current of 400 A under short-circuit conditions.

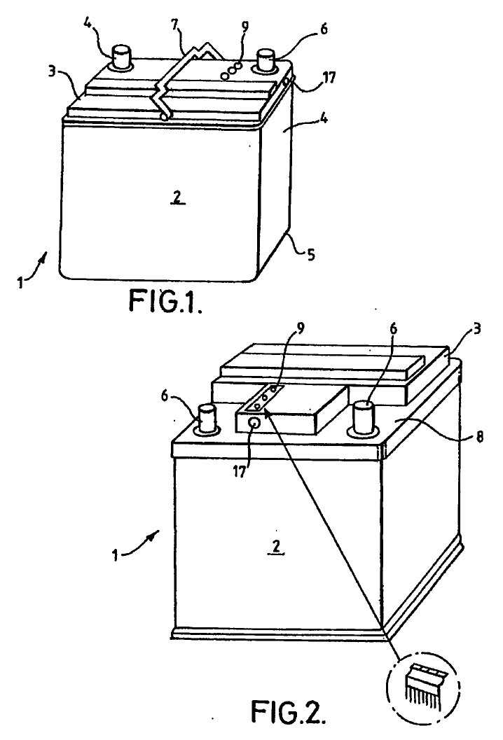

Generally, the battery 1 comprises of a casing 2 and a cover 3. The casing further comprises of an upper portion 4 and a lower portion 5. An upwardly extending internal wall (not shown) rises from the lower portion 5 to define an adjacently located cell (not shown). An alternative embodiment may be a single-cell type battery. For automotive applications, a six-cell lead-acid battery provides a typical 12V storage battery. Positive and negative terminals 6 are also disposed on the cover. The terminals are correspondingly connected to each of the cells anode and cathode to provide the required voltage for the battery. The cover 3 may also be provided with a total of six inlet means (not shown), each inlet means correspond to each battery cell and the inlet means is used for filling or topping-up of electrolyte for the battery. An integrated unified venting assembly (also not shown) may also be used to provide a substantially maintenance-free battery. A handle 7 is pivotally mounted to the cover and the handle is capable of being folded or unfolded from its resting position. The handle is also capable of being flipped to its either side and to rest on the guide (not shown). The handle allows for one-handed lifting of the battery (not shown in FIG. 2).

As shown in FIG. 2, the battery terminals 6 are disposed on a lowered section 8 of the cover 3 for a DIN (European) standard type battery. Such arrangement is particularly adapted for providing flush mounted battery terminals, which reduces possibility of a short circuit occurring if it happens that the a panel of the vehicle comes into contact with the battery, for example, as the result of an accident. Alternatively, the terminals may be mounted to the cover forming a raised terminal as commonly found on JIS (Japanese standards) compliant battery, as shown in FIG. 1. To eliminate the likelihood of a short circuit, the terminals might also be slightly shortened.

A display means 9, is also provided on the cover, such display means being used to display the condition and actual capacity of the battery, as will be described. Such a display means 9 may also help to display whether the battery is being charged sufficiently by the vehicle charging system while the engine is running. In effect, the system could also be used to monitor the charging pattern of the charging system during engine operation. Further, it is also able to detect whether there is any leakage is present in the electrical system to indicate that this has occurred. Normally, if the battery were not being charged sufficiently, then it could be presumed that the alternator of the vehicle is at fault or there is a fault in other components within the charging system. An electronic circuit capable of delivering such advantageous features is preferably assembled and embedded within the battery cover 3. The circuit operation will be discussed in detail later. An optional communication port 17, preferably to generate output signals according to the one of the CAN communication protocols (e.g. I²CAN), is also provided on the cover (FIG. 1, FIG. 2).

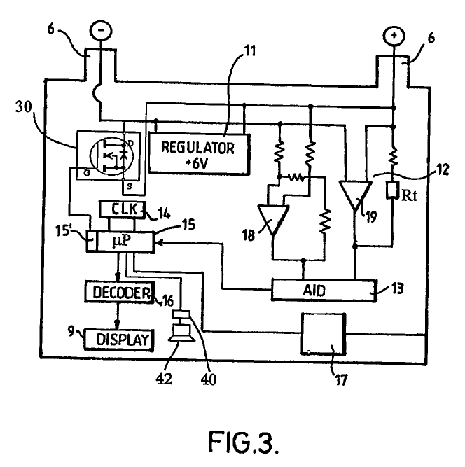

Now referring to FIG. 3, there is shown the diagrammatic representation (not to scale) of a battery embodying the invention having such an electronic circuit. As indicated earlier, the circuit is preferably embedded within the cover 3, mainly for its space saving and compactness. The display means may include a light emitting diode (LED), segmented display device, a bar display or any other suitable device, optionally capable of displaying icons, known to those skilled in the technology. The display means is also preferably flush-mounted to the cover so that it is flatly mounted to the same. If an LED is to be used, then preferably, at least three different illumination modes are provided. For example, the LEDs may be of different colours, such as red, yellow and green LEDs as depicted in FIGS. 1 and 2. Such three different colours of illumination correspond to three different states of measured condition in the battery. While the engine is not running or during a low electrical load, a high potential across the terminals in a good condition battery will illuminate one of the LEDs, usually the yellow LED. Such high potential would be between 12.0V and 13.5V. If the red LED illuminates, then this indicates that the battery is either weak or there is some electrical leakage in the system. The electromotive force of a weak battery may be below 12.0V, depending upon the nature of the problem with the battery. If the battery is found to be in a good condition and yet the red LED still illuminates, it may mean that leakage in the electrical system causes the battery to be self-discharging or discharged by external components of the vehicle. This indicates that remedial action must be taken if problems are to be avoided.

While the engine is running, the system is used to detect and monitor the condition of the charging system. In particular, a fully-operational charging system will illuminate the green LED because the illumination of such LED is set at above 13.6V. If for some reason the other LED were illuminated, then it would indicate that the charging system is at fault. It may mean that the alternator is incapable of charging the battery or there is a component fault in the system. As such, the charging pattern of the charging system could also be indicated on the display means.

A more comprehensive display for use in embodiments of the invention is shown in FIG. 7. A segmented display device 40 capable of exhibiting the actual reading of the measured electromotive force (and thus battery condition) could also be used along with bar or icon display 42 that correspond to the actual measured electromotive force in the battery. The display may also include an indicator 44 that show that the battery is charging correctly when the engine is running, an indicator 46 that warns that the battery condition is poor, and an indicator 48 that shows when the battery has reached the end of its life. A display such as this may be provided in the battery itself or within the vehicle, depending upon the type of embodiment with which it will be provided.

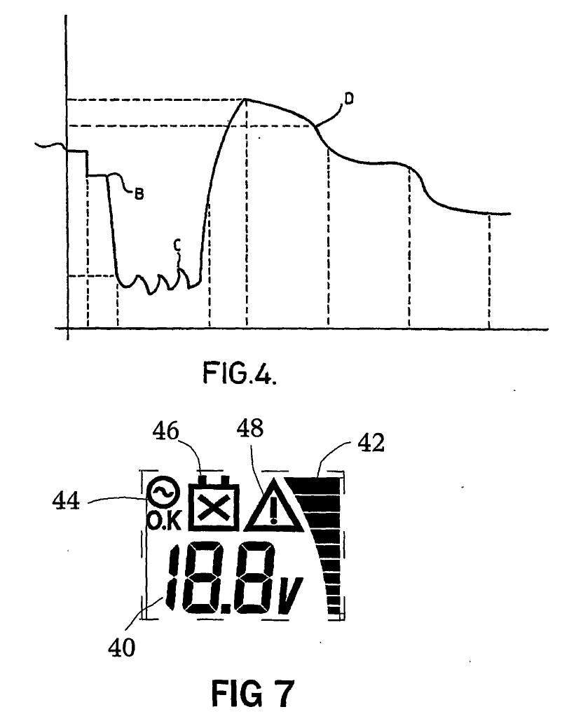

To illustrate how such values are set as references to indicate the actual condition of the battery and its charging system, reference is now made to FIG. 4, where the figure shows a characteristic waveform of the electromotive force in a good and fully operational storage battery during different stage of engine operation. For instance, while the ignition key is in the off position (A) or during open-circuit or low-load conditions, the potential across the terminals would normally be nearly 13.2V, particularly just after the battery had been charged or after engine running. When the ignition is switched on (B), the voltage will drop to about 12.3V. Therefore, a storage battery that is in good condition would normally have a potential between 12.3V to 13.2V across the terminals. In such a situation, the yellow LED will be illuminated, because the yellow LED is set at such voltage range to be energised. During starting of the engine (C), the voltage across the terminals may drop to as low as 9.0V and then rise steadily to about 15.5V once the engine starts, depending on the ambient temperature. It will then slowly drop to about 14.0V (D). It will remain more or less at this level during subsequent engine operation. In that condition, the battery is being charged by the charging system and the green LED will be illuminated to indicate that this is the case. (All of these voltages are given by way of example only and are subject to change to meet with the requirements of different manufacturers.)

Referring back to FIG. 3, the operation of the electronic circuit will now be explained. The circuit includes a regulated (e.g. To 5V or 6V) power section 11 to energise the circuit, a voltage and impedance reference section 12, an analogue-to-digital converter 13, a clock-signal generator 14, a microcontroller 15, a decoder 16 and the display means 9. A communication protocol stage 17, preferably using the CAN bus communication protocol, is also optionally provided to the circuit to transmit the processed signal to a remotely connected display panel or to the engine management system. The microcontroller 15 controls operation of all of the other components of the system. The microcontroller 15 is also used to process measured electromotive force and the internal resistance of the battery in digital form, calculate the current and compare it with that of a predetermined values set in the microcontroller 15 so as to provide the previously described details. An audio oscillator 40 is controlled by the microcontroller 15, the output of the oscillator being connected to a sounder 42. This can be operated in addition to any visual warning device to indicate an abnormal battery or charging condition.

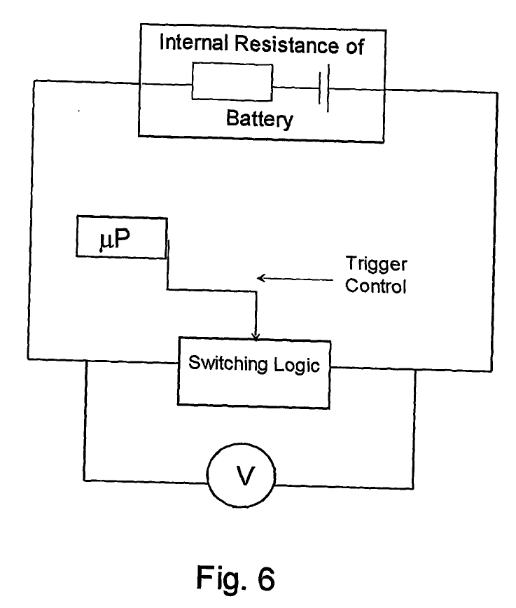

The associated parameters available in the battery will be represented as voltage and impedance values across the terminals. The impedance is derived from measurement of the maximum current that is produced by the amplifier when a low resistance is momentarily connected across the battery terminals. This principle is illustrated in FIG. 6, in which the battery is represented as a voltage source in series with a resistor in the upper box and the apparatus embodying the invention is represented by a switch, a resistor and a voltmeter.

In this embodiment, the switch and the resistor and the switch are both constituted by a solid state switch, which in this embodiment is a MOSFET device 30. This acts as a fast switch under the control of the microcontroller 15 through control logic 15′. It also has a predictable and low internal resistance. It can, therefore, be modelled as an ideal switch and an ideal resistor connected in series.

This voltage that appears across the MOSFET during each current pulse is amplified by the operational amplifiers 18, 19 in the analogue domain. The resistors Rt on the inputs of the amplifiers serve to compensate for variations in ambient temperature.

The analogue signals from such amplification are then converted into digital signals by the analogue-to-digital converter 13. In order to keep the length of the current pulse suitably short, the analogue-to-digital converter may complete its voltage measurement over several successive pulses, a sub-range of the total voltage range being scanned during each pulse.

The microcontroller computes and processes digital signals from the analogue-to-digital converter 13, and, based upon the measured voltage, the microcontroller provides an output that selectively energises the corresponding display means. The microcontroller includes a microprocessor, memory unit and an input/output. The predetermined values of reference voltages and current associated with a good battery of the similar type as discussed earlier are set in the microcontroller itself through its operating software. A clock signal is provided by the clock signal generator 14, which preferably includes of a crystal oscillator for its inherent stability. The decoder 16 is used to decode logical data signals output from the microcontroller 15 to drive the display means 9 such that the illumination of the display means corresponds to the actual condition of the battery and the charging system as discussed above. As also indicated earlier, communication between the electronic circuit of the battery and a remote display panel or engine management unit is made possible via an optional I²C bus communication port which is preferably provided on the side of the storage battery. Such optional communication feature provides further convenience to the user, because the condition of the battery, by way of the display means, may be exhibited on the vehicle dashboard or at any other suitable location, or by way of an audio sounder.

Following starting of the engine, the battery is recharged to replace energy drawn from it during starting or operation of electrical components of the vehicle prior to starting the engine. It is desirable that this charging process takes place as quickly as possible, yet must not be so fast that the current flowing within the battery will cause it damage. The current and voltage are controlled by the regulator pack associated with the vehicle's alternator. The regulator pack uses a sensor line that is connected to the battery to monitor the battery voltage. In a modification to the invention, the apparatus provides a connection to which the sensor line is connected. By adjusting the voltage that is applied through the connection to the sensor line, the apparatus can control the output of the alternator. If the apparatus reduces the voltage in the sensor line, the regulator pack treats this as if it were a reduction in the battery voltage, and will raise its output to compensate. Contrarily, if the apparatus increases that voltage, then the alternator will reduce its output because it will receive a sensing signal that is equivalent to a high battery voltage.

It will be readily apparent that a storage battery constructed as an embodiment of the present invention is convenient to use and its operational life might even be extended due to the continuous monitoring. This is in particularly the case if a fault were to occur because appropriate rectification measures may be taken promptly before any damage is done to the battery.

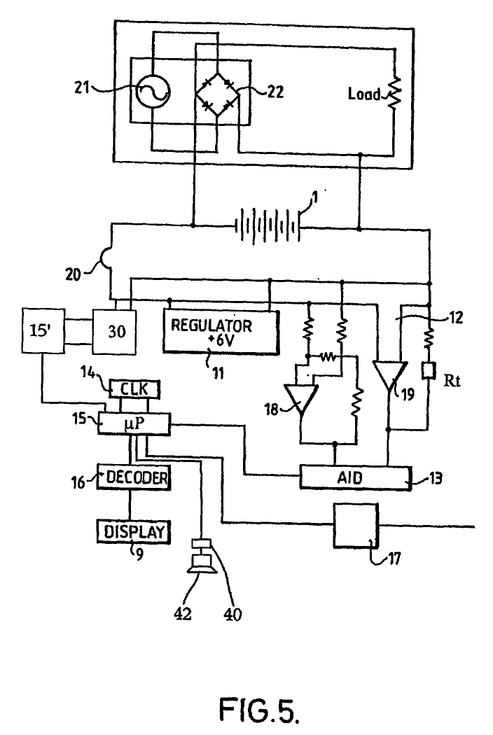

FIG. 5 shows yet another diagrammatic representation of a battery that is connected to its charging system and in particular, the charging system of the vehicle where such battery is used. Further, as it can be seen in the drawing, a switch 20 is also included in the circuit to allow selective actuation of the detection and indicating means. Preferably, the switch is only actuated once the battery has been installed on the vehicle. This is in particular to reduce the possibility of energy being drained from the battery during its transport or storage. During engine operation, the charging system that normally includes an alternator 21, a full-wave rectifier 22 and voltage regulator (not shown) would generate at least 13.6V across the battery terminals. In this situation, the green LED is illuminated to indicate that the charging system is fully-operational as indicated earlier. Any lower potential from the charging system would be detected by the system and indicated as a fault by illumination of one of the LEDs as discussed above.

To avoid draining the battery, the microcontroller enters a sleep mode in the event that the battery voltage does not change for a significant period of time, as will happen in a vehicle battery when the vehicle is out of use. No current measurements are made in sleep mode. Many faults, such as insulation leakage, temperature-dependent transient plate faults cause the voltage to change, and so waken the apparatus from sleep mode whereby the fault can be detected and indicated as appropriate.

A recognised mode of failure of an alternator is a partial failure of its rectifier pack. A typical alternator includes a three-phase AC generator, and a rectifier having six diodes converts its output to DC. If just one or two of these diodes fails, especially into an open-circuit state, the alternator will continue to provide an output, but its ability to charge the battery will be reduced. This may manifest itself in occasional loss of charge, for example after use of a large number of electrical accessories of after several successive periods of short engine operations after successive starts. However, the time-averaged voltage measured by a conventional volt meter may be only slightly affected. A properly functioning alternator provides a DC output that is a steady voltage upon which a ripple is superimposed. However, if any one diode fails, there will be a notable voltage drop during the time that its conduction would be required. Embodiments of this apparatus can monitor the output of the alternator continuously, and issue a warning (using the display or through an interface to external apparatus) or enter an alarm condition if the output suggests that such a failure has occurred. For example, if such a fault were detected, the green LED would be extinguished and the yellow LED lit instead.

Low potential is well-recognised as being an indication of an immediate problem with the state of charge of the battery, but, as the inventor has determined, does not give an indication of the health or expected lifespan of the battery, which is determined by measurement of the internal resistance, as discussed above. Thus, it will be seen that embodiments of the invention can provide both an indication of the immediate state of charge of the battery and an associated charging system, as well as its state of health and longer-term condition.

While the preferred embodiments of the present invention have been described, it should be understood that various changes, adaptations and modifications might be made thereto within the scope of the claims. For example, instead of an LED display, an LCD system may be used. This might, for example, display icons to indicate the status of the battery.

What is claimed is:

1. Apparatus for monitoring the condition of a storage battery comprising first and second connection conductors each for connection to a respective output terminal of the battery, switching means connected in series with a resistance between the connection conductors and voltage measurement means connected in parallel with the resistance, in which the switching means operates to complete the circuit to allow current to flow between the battery terminals, and voltage measurement means being operative to measure the potential across the resistance during such current flow, the period during which the switching means is closed and the frequency of such closures being such that the power dissipated by the apparatus averaged over several closures being substantially less than the instantaneous power delivered by the battery and in which the current drawn during each closure is of the same order as the short-circuit current of the battery.

2. Apparatus according to claim 1 in which the switching means includes a solid-state switching device.

3. Apparatus according to claim 2 in which the gate of the solid-state switching device is controlled by an output of a microcontroller.

4. Apparatus according to claim 1 in which the solid-state switching device is a MOSFET.

5. Apparatus according to claim 1 in which the solid-state switching device is a bipolar transistor.

6. Apparatus according to claim 1 that comprises an amplifier to amplify the voltage that appears across the resistance.

7. Apparatus according to claim 1 comprising an analogue-to-digital converter to measure the voltage that appears across the resistance.

8. Apparatus according to claim 1 in which the duration of each closure has an order of magnitude of 10⁻⁵ seconds.

9. Apparatus according to claim 1 in which the resistance is of order 10⁻³ ohms.

10. Apparatus according to claim 1 further comprising indicating means operative to indicate the state of a battery to which the apparatus is connected.

11. Apparatus according to claim 10 in which the indicating means comprises indicators that can display lights of one of several alternative colours, the particular colour that is being displayed being indicative of the state of the battery.

12. Apparatus according to claim 10 in which the indicating means includes a display device that can display one or more alphanumeric characters or one or more icons, the display being representative of the state of the battery.

13. Apparatus according to claim 1 further comprising interface means operative to communicate the state of the battery to external apparatus.

14. Apparatus according to claim 13 in which the external apparatus is an electronic control bus of a vehicle.

15. Apparatus according to claim 1 including communications means for conveying the state of a battery to a remote location.

16. Apparatus according to claim 15 in which the communication means operates using wireless telecommunication, either as a radio link or cellular telephony.

17. Apparatus according to claim 1 further including means for monitoring the output of a charging device for the battery and for issuing a warning in the event of its whole or partial failure.

18. Apparatus according to claim 17 which monitors the characteristic output of the charger over time and issues a warning in the event that this suggests whole or partial failure of the charging means.

19. Apparatus according to claim 1 being programmed to enter a sleep mode in which testing is suspended in the event that the battery EMF remains substantially constant for a predetermined period.

20. A lead-acid storage battery comprising apparatus for monitoring the condition of a storage battery according to claim 1.

21. (canceled)

22. A storage battery having detection and indicating means integrally assembled on it, comprising: a casing having an upper portion and a lower portion, at least a cell defined within the casing; a cover enclosing the upper portion of the casing; a pair of terminals mounted on the cover, each terminal is electrically connected to the corresponding anode and cathode of the cell; characterised in that, the detection and indicating means includes apparatus for monitoring the condition of a storage battery comprising first and second connection conductors each for connection to a respective output terminal of the battery, switching means connected in series with a resistance between the connection conductors and voltage measurement means connected in parallel with the resistance, in which the switching means operates to complete the circuit to allow current to flow between the battery terminals, and voltage measurement means being operative to measure the potential across the resistance during such current flow, the period during which the switching means is closed and the frequency of such closures being such that the power dissipated by the apparatus averaged over several closures being substantially less than the instantaneous power delivered by the battery and in which the current drawn during each closure is of the same order as the short-circuit current of the battery.

23. A storage battery according to claim 22 further characterised in that the electronic circuit further includes a communication means to transmit the processed signal to other display means remotely position from the storage battery.

24. A storage battery according to claim 23 further characterised in that the display means includes a light emitting diode or a liquid crystal display device.

25. A storage battery according to claim 23, further characterised in that the display means is mounted flush with the cover.

26. A storage battery according to claim 24 further characterised in that the display means includes a segmented display device for exhibiting a measured value.

27. A storage battery according to claim 22 in which the display device is capable of displaying one or more icons to indicate the state of the battery.

28. A storage battery according to claim 22 further characterised in that the electronic circuit is assembled and embedded within the cover.

29. A storage battery according to claim 22 further characterised in that the storage battery for use in a motor vehicle, and the display means is adapted to indicate the condition of the battery during the engine off and indicate the condition of the charging system of the motor vehicle when the engine is in operation.

30. A storage battery according to claim 22 further characterised in that the electronic circuit is capable of detecting leakage of energy from the battery and indicating the same on the display means while the engine is not running.

31. A storage battery according to claim 22 in which the detection and indicating means measures the total potential across all cells of the battery and the internal resistance of the storage battery.

32. A storage battery according to claim 22 including communication means for conveying the state of the battery to apparatus external of the battery.

33. A storage battery according to claim 32 in which the apparatus external to the battery is a control bus of a vehicle.

34. A storage battery according to claim 32 in which the apparatus external to the battery includes communication means for communicating the state of the battery to a remote location.

35. (canceled)

36. (canceled)
